(19) United States
(12) Patent Application Publication
(10) Pub. No.: US 2024/0233151 A1
(43) Pub. Date: Jul. 11, 2024

(54) ADAPTIVE AND EFFICIENT DEPTH ESTIMATION DEVICE AND METHOD THEREOF

(71) Applicant: OmniEyes Co., Ltd. Taiwan Branch, Taipei City (TW)

(72) Inventors: Chung-Yuan CHEN, Taipei City (TW); Yi-Yen WANG, Taipei City (TW); Chun-Ting CHOU, Taipei City (TW)

(21) Appl. No.: 18/150,593

(22) Filed: Jan. 5, 2023

(51) Int. Cl. G06T 7/50; G06T 5/00; G06T 7/246; G06T 7/70

(52) U.S. Cl. CPC G06T 7/50; G06T 5/006; G06T 7/248; G06T 7/70; G06T 2207/30252

(57) ABSTRACT

An adaptive and efficient depth estimation device for a vehicle is provided, which includes a speed detection circuit, an image capturing module, an object detection circuit and an image projection processing circuit. The speed detection circuit is configured to detect a speed of the vehicle. The image capturing module is configured to capture a first image and a second image. The object detection circuit is configured to determine a first position of target object in the first image and a second position of target object in the second image. The image projection processing circuit is configured to convert the first position and the second position to a first projected position and a second projected position by using transform matrix and determine a first relative position and a second relative position of the target object according to the speed of the vehicle, the first projected position and the second projected position.

### FIELD OF THE INVENTION

The invention relates to a depth estimation device and method thereof, and more particularly, to an adaptive and efficient depth estimation device and method thereof capable of estimating depth information of target object without additional expensive depth camera or lidar equipment.

### BACKGROUND OF THE INVENTION

Depth of an object is the distance of the object in the scene to the camera. However, a common vehicle-mounted RGB camera cannot capture the object's depth information, such that image information captured by the common RGB camera would not be sufficient to estimate the depth of the object in the scene or the relative position between the object and the vehicle, thus limiting the development of higher level vehicle services, such as Advanced Driver Assistance Systems (ADAS). Furthermore, current vehicle-mounted device usually estimates the depth of the object in the scene or the relative position between the object and the vehicle by using a depth camera or a light detection and ranging (lidar) device, thereby resulting in high production cost and also increasing the complexity and time for manufacturing and assembly. Thus, there is a need for improvement.

### SUMMARY OF THE INVENTION

It is therefore an objective of the present invention to provide an adaptive and efficient depth estimation device and method thereof to solve the abovementioned problem.

An embodiment of the present invention discloses an adaptive and efficient depth estimation device, applied for a vehicle, comprising: a speed detection circuit, disposed on the vehicle and configured to detect a speed of the vehicle; an image capturing module, disposed on the vehicle and configured to capture a first image at a first time point and a second image at a second time point; an object detection circuit, coupled to the image capturing module and configured to determine a first position of a target object in the first image and a second position of the target object in the second image; and an image projection processing circuit, coupled to the object detection circuit and the speed detection circuit, and configured to convert the first position and the second position to a first projected position and a second projected position by using a transform matrix, and configured to determine a first relative position of the target object at the first time point and a second relative position of the target object at the second time point in a world coordinate according to the speed of the vehicle, the first projected position and the second projected position.

An embodiment of the present invention discloses an adaptive and efficient depth estimation method, applied for a vehicle, comprising: detecting a speed of the vehicle; capturing a first image at a first time point and a second image at a second time point; determining a first position of a target object in the first image and a second position of the target object in the second image; and converting the first position and the second position to a first projected position and a second projected position by using a transform matrix; and determining a first relative position of the target object at the first time point and a second relative position of the target object at the second time point in a world coordinate according to the speed of the vehicle, the first projected position and the second projected position.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an adaptive and efficient depth estimation device according to an embodiment of the present invention.

FIG. 2 is a flow diagram of a procedure according to an embodiment of the present invention.

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

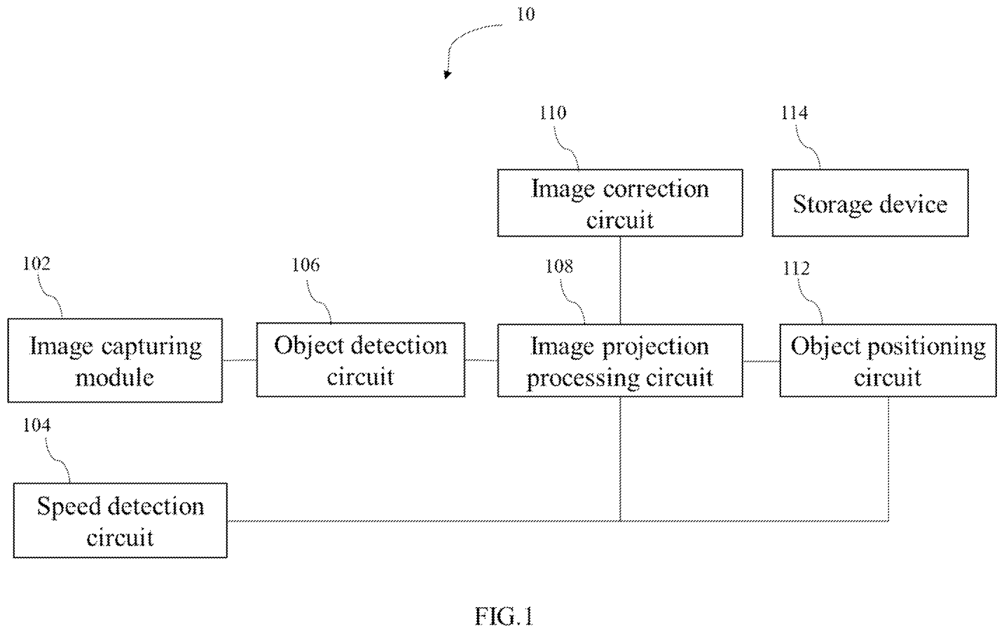

Please refer to FIG. 1, which is a schematic diagram of an adaptive and efficient depth estimation device 10 according to an embodiment of the present invention. The depth estimation device 10 of the embodiment of the present invention may be disposed and applied in a vehicle. For example, the depth estimation device 10 may be integrated on an on-board unit (OBU) of the vehicle, but not limited thereto. The depth estimation device 10 includes an image capturing module 102, a speed detection circuit 104, an object detection circuit 106, an image projection processing circuit 108, an image correction circuit 110, an object positioning circuit 112 and a storage device 114. The image capturing module 102 is disposed on the vehicle and configured to capture images sequentially. For example, the image capturing module 102 may be a forward-facing image capturing module for capturing images of a front side of the vehicle. The image capturing module 102 may be disposed at any position of the vehicle, which is capable of capturing images of the front side of the vehicle. In an embodiment, the image capturing module 102 may be installed on a windshield of the vehicle, but not limited thereto. The image capturing module 102 may be a camera, a car recorder, a dash cam or any other device capable of capturing images. The speed detection circuit 104 is disposed on the vehicle and configured to detect a speed of the vehicle. The speed detection circuit 104 may include a global positioning system (GPS) and an inertial measurement unit (IMU), but not limited thereto. Preferably, the speed detection circuit 104 may accurately estimate the geometric position, longitude, latitude and speed of the vehicle. The object detection circuit 106 is coupled to the image capturing module 102, and configured to receive the images captured by the image capturing module 102 and determine the target object in the images and the corresponding positions of the target object in the images. The image projection processing circuit 108 is coupled to the speed detection circuit 104 and the object detection circuit 106. The image projection processing circuit 108 is configured to convert the position of the target object in the image to a projected position by using a transform matrix and determine a relative position of the target object in a world coordinate according to the speed of the vehicle and the projected position. The storage device 144 is configured to store speed information of the vehicle detected by the speed detection circuit 104 and the images captured by the image capturing module 102.

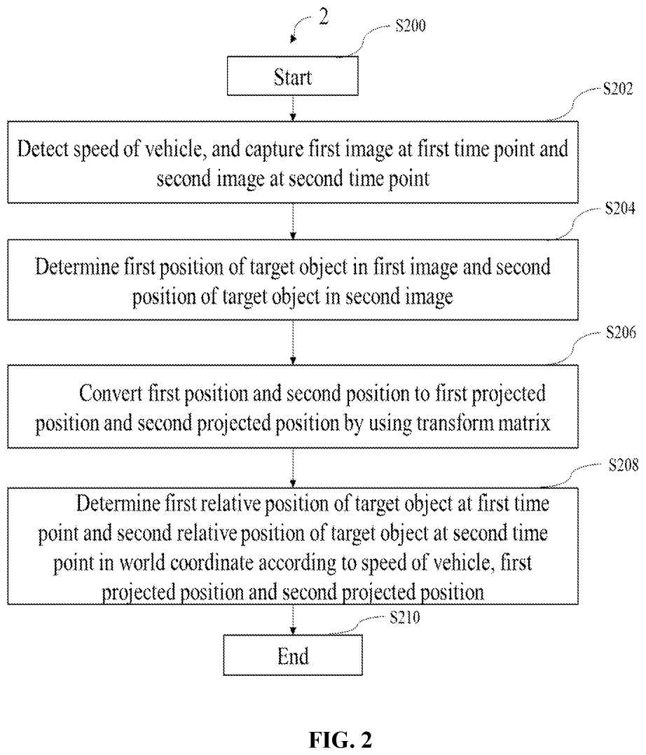

For an illustration of the operations of the depth estimation device 10, please refer to FIG. 2. FIG. 2 is a flow diagram of a procedure 2 according to an embodiment of the present invention. The flowchart in FIG. 2 mainly corresponds to the operations on the depth estimation device 10 shown in FIG. 1.

The procedure 2 includes the following steps:

Step S200: Start.

Step S202: Detect speed of vehicle and capture first image at first time point and second image at second time point.

Step S204: Determine first position of target object in first image and second position of target object in second image.

Step S206: Convert first position and second position to first projected position and second projected position by using transform matrix.

Step S208: Determine first relative position of target object at first time point and second relative position of target object at second time point in world coordinate according to speed of vehicle, first projected position and second projected position.

Step S210: End.

According to the procedure 2, in Step S202, the speed detection circuit 104 is configured to detect the speed of the vehicle. The image capturing module 102 is configured to capture continuous image frames progressively at a constant sampling rate. For example, the image capturing module 102 may capture a first image at a first time point and capture a second image at a second time point after the first time point. Speed information of the vehicle detected by the speed detection circuit 104 and images captured by the image capturing module 102 may be stored into the storage device 114.

In Step S204, the object detection circuit 106 receives the first image and the second image captured by the image capturing module 102, and identifies the target object in the first image and the second image. Further, the object detection circuit 106 determines a first position of the target object in the first image and a second position of the target object in the second image. The target object may include the object seen by the image capturing module 102. In an embodiment, the target object may be an object related to traffic rules and/or driving behavior, such as traffic lights (e.g., stoplights), traffic signs (e.g., stop signs), surrounding buildings, pedestrians, or other vehicles. The object detection circuit 106 may detect the absolute position of the object of interest in each image frame. For example, the object detection circuit 106 may detect the target object in the image frames by using a deep neural network model and determine movement information of the target object in the image frames by using the optical flow algorithm. For example, the object detection circuit 106 may determine a position p1 of the target object in a first image captured at a time point t1 and determine a position p2 of the target object in a second image captured at a time point t2. For each image, the object detection circuit 106 may process the target object of interest represented by label, bounding box and classification score, and refine the box position of the bounding box and track ID assignment by using multiple object tracking algorithm. For each image, the object detection circuit 106 may output list information of the tracked object. The list information of the tracked object may include a set of attributes associated with the tracked object, such as label, bounding box, detection score and tracking ID of the tracked object.

In Step S206, the image projection processing circuit 108 is configured to convert the first position into a first projected position and convert a second projected position into a second projected position by using a transform matrix. The transform matrix may be a homography transform matrix. The transform matrix represents a transformation which maps an image plane to another plane. The said another plane may be a ground plane, a sky plane or any other horizontal reference plane. For example, in Step S204, the object detection circuit 106 determines the position p1 of the target object in the first image captured at the time point t1 and determine the position p2 of the target object in the second image captured at the time point t2. Further, in Step S206, the image projection processing circuit 108 may convert the position p1 of the target object in the first image captured at the time point t1 from the image plane to the horizontal reference plane by using the transform matrix so as to generate a projected position q1. The image projection processing circuit 108 may convert the position p2 of the target object in the second image captured at the time point t2 from the image plane to the horizontal reference plane by using the transform matrix so as to generate a projected position q2. For example, suppose a unit sky plane is one meter above the image capturing module 102 and parallel to ground, and a camera height of the image capturing module 102 is above the ground. In an embodiment, homogenous coordinates of the positions p1 and p2 in an image plane may be expressed as follows:

$${p}_{1} = [ \begin{matrix}{x}_{1} \\ {y}_{1} \\ 1\end{matrix} ] , {p}_{2} = [ \begin{matrix}{x}_{2} \\ {y}_{2} \\ 1\end{matrix} ] \qquad ( 1 )$$

Projected coordinates of the projected positions q1 and q2 in a unit sky plane may be expressed as follows:

$${q}_{1} = [ \begin{matrix}{x}_{1}^{′} \\ {y}_{1}^{′} \\ 1\end{matrix} ] , {q}_{2} = [ \begin{matrix}{x}_{2}^{′} \\ {y}_{2}^{′} \\ 1\end{matrix} ] \qquad ( 2 )$$

In an embodiment, the projected positions q1 and q2 may be calculated by the image projection processing circuit 108 according to the following equations:

$${s}_{1} {q}_{1} = {H}_{p \to {w}_{s k y}^{*}} \times {p}_{1} \qquad ( 3 )$$

$${s}_{2} {q}_{2} = {H}_{p \to {w}_{s k y}^{*}} \times {p}_{2} \qquad ( 4 )$$

where q1 represents the first projected position; q2 represents the second projected position; H_{p→w}_{_{sky}}_{^{*}} represents the homography transform matrix for transforming from an image plane to an unit sky plane (e.g., a sky plane which is one meter above the image capturing module 102 and parallel to ground); p1 represents the first position; p2 represents the second position; s1 represents a first coefficient; and s2 represents a second coefficient.

On the other hand, in Step S206, the image correction circuit 110 may optimize the transform matrix according to at least one of a fish-eye undistortion parameter and a camera un-tilt parameter. The image correction circuit 110 may correct image distortion that is caused by optical component design by using the fish-eye undistortion parameter for optimizing the transform matrix. The image correction circuit 110 may correct image distortion that is caused by the component installation error and misalignment of the image capture module 102 by using the camera un-tilt parameter for optimizing the transform matrix.

In Step S208, the image projection processing circuit 108 is configured to determine a first relative position of the target object at the first time point and a second relative position of the target object at the second time point in a world coordinate according to the speed of the vehicle detected in Step S202, the first projected position and the second projected position determined in Step S206. For example, the image projection processing circuit 108 may calculate a scalar coefficient according to the speed of the vehicle, a time difference between the first time point and the second time point and a difference value between a coordinate value of the first projected position along a first coordinate axis (e.g., along x-axis) and a coordinate value of the second projected position along the first coordinate axis, and accordingly calculate the first relative position of the target object at the first time point and the second relative position of the target object at the second time point in the world coordinate. In an embodiment, the scalar coefficient may be calculated by the image projection processing circuit 108 according to the following equations:

$$k = \frac{v \times ( {t}_{2} - {t}_{1} )}{( {x}_{2}^{′} - {x}_{1}^{′} )} \qquad ( 5 )$$

where k represents the scalar coefficient; v represents the speed of the vehicle; t1 represents the first time point; t2 represents the second time point; x′₁ represents the coordinate value of the first projected position q1 along x-axis; and x′₂ represents the coordinate value of the second projected position q2 along x-axis.

Moreover, in Step S208, the image projection processing circuit 108 may calculate a first relative position of the target object at the first time point t1 and a second relative position of the target object at the second time point t2 in the world coordinate according to the scalar coefficient k, coordinate values of the projected positions q1 and q2 in the first coordinate axis (e.g., x-axis) and the second coordinate axis (e.g., y-axis) and a camera height of the image capturing module 102. The camera height of the image capturing module 102 may be the vertical distance from the installation position of the image capturing module 102 to the reference plane (e.g., ground plane) ground plane. As such, in embodiments of the present invention, the reprojected position may be scaled according to the ratio of the vehicle speed to the trajectory length, and the relative position may be calculated based on the reference plane with the same height. The first relative position of the target object at the first time point in the world coordinate may be the relative position of the target object with respect to the image capture module 102 at the first time point. The second relative position of the target object at the second time point in the world coordinate may be the relative position of the target object with respect to the image capture module 102 at the second time point. In an embodiment, the first relative position of the target object at the first time point and the second relative position of the target object at the second time point in the world coordinate may be calculated by the image projection processing circuit 108 according to the following equations:

$${r}_{1} = [ \begin{matrix}{kx}_{1}^{′} \\ {ky}_{1}^{′} \\ k + h\end{matrix} ] , {r}_{2} = [ \begin{matrix}{kx}_{2}^{′} \\ {ky}_{2}^{′} \\ k + h\end{matrix} ] \qquad ( 6 )$$

where r₁ represents the first relative position of the target object at the first time point t1 in the world coordinate; r₂ represents the second relative position of the target object at the second time point t2 in the world coordinate; k represents the scalar coefficient; x′₁ represents the coordinate value of the first projected position q1 along x-axis; x′₂ represents the coordinate value of the second projected position q2 along x-axis; y′₁ represents the coordinate value of the first projected position q1 along y-axis; y′₂ represents the coordinate value of the second projected position q2 along y-axis; and h represents the camera height of the image capturing module 102.

Moreover, in Step S208, the object positioning circuit 112 may calculate geographic location information of the target object according to the positioning information and bearing of the GPS, and the relative position information of the target object in the world coordinate calculated by the image projection processing circuit 108.

To sum up, the embodiments of the present invention may quickly and accurately calculate the relative position of the target object in the world coordinates based on the real-time speed of the vehicle and the movement information of pixel coordinate position of the target object after conversion and correction, thus realizing the depth estimation of three dimensional position of target object with respect to the image capture module 102, without requiring additional expensive depth camera or lidar device.

In the embodiments of the present invention, the speed detection circuit 102, the image capturing module 104, the object detection circuit 106 and the image projection processing circuit 108 may be utilized to determine the relative position of the target object during an on line execution phase. The image correction circuit 110 may be utilized to generate the fish-eye undistortion parameter and the camera un-tilt parameter and optimize the transform matrix according to the fish-eye undistortion parameter and the camera un-tilt parameter during an off line execution phase. The speed information of the vehicle detected by the speed detection circuit 104 and images captured by the image capturing module 102 may be stored into the storage device 114. The image correction circuit 110 may read the speed information and images stored in the storage device 114 for calculate the fish-eye undistortion parameter and the camera un-tilt parameter. In addition, the image correction circuit 110 and the storage device 114 may be integrated into a cloud server.

Those skilled in the art should readily make combinations, modifications and/or alterations on the abovementioned description and examples. The abovementioned description, steps, procedures and/or processes including suggested steps can be realized by means that could be hardware, software, firmware (known as a combination of a hardware device and computer instructions and data that reside as read-only software on the hardware device), an electronic system or combination thereof. Examples of hardware can include analog, digital and/or mixed circuits known as microcircuit, microchip, or silicon chip. Examples of the electronic system may include a system on chip (SoC), system in package (SiP), a computer on module (COM), and the depth estimation device 10. Any of the above-mentioned procedures and examples above may be compiled into program codes or instructions that are stored in a storage device. The storage device may include a computer-readable storage medium. The storage device may include read-only memory (ROM), flash memory, random access memory (RAM), subscriber identity module (SIM), hard disk, floppy diskette, or CD-ROM/DVD-ROM/BD-ROM, but not limited thereto. The processing circuit may read and execute the program codes or the instructions stored in the storage device for realizing the above-mentioned functions. Each of the object detection circuit 106, the image projection processing circuit 108, the image correction circuit 110, the object positioning circuit 112 and the processing circuit may be a central processing unit (CPU), a microprocessor, a digital signal processor (DSP), a programmable controller, a graphics processing unit (GPU), a programmable logic device (PLD), an electronic control unit (ECU) or other similar devices or combination of these devices, but not limited thereto.

In summary, the embodiments of the present invention may quickly and accurately calculate the relative position of the target object in the world coordinates based on the real-time speed of the vehicle and the movement information of pixel coordinate position of the target object after conversion and correction, thus realizing the depth estimation of three dimensional position of target object with respect to the image capture module, without requiring additional expensive depth camera or lidar equipment.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An adaptive and efficient depth estimation device, applied for a vehicle, comprising:
(a) a speed detection circuit, disposed on the vehicle and configured to detect a speed of the vehicle;
(b) an image capturing module, disposed on the vehicle and configured to capture a first image at a first time point and a second image at a second time point;
(c) an object detection circuit, coupled to the image capturing module and configured to determine a first position of a target object in the first image and a second position of the target object in the second image; and
(d) an image projection processing circuit, coupled to the object detection circuit and the speed detection circuit, and configured to convert the first position and the second position to a first projected position and a second projected position by using a transform matrix, and configured to determine a first relative position of the target object at the first time point and a second relative position of the target object at the second time point in a world coordinate according to the speed of the vehicle, the first projected position and the second projected position.

2. The adaptive and efficient depth estimation device of claim 1, wherein the speed detection circuit is a global positioning system.

3. The adaptive and efficient depth estimation device of claim 1, wherein the image capturing module is a forward-facing image capturing module for capturing images of a front side of the vehicle, such that the image capturing module captures the first image at the first time point and the second image at the second time point.

4. The adaptive and efficient depth estimation device of claim 1, wherein the image projection processing circuit is configured to calculate a scalar coefficient according to the speed of the vehicle, a time difference between the first time point and the second time point and a difference value between a coordinate value of the first projected position along a first coordinate axis and a coordinate value of the second projected position along the first coordinate axis, and calculate the first relative position of the target object at the first time point and the second relative position of the target object at the second time point in the world coordinate according to the first projected position, the second projected position and the scalar coefficient.

5. The adaptive and efficient depth estimation device of claim 4, wherein the scalar coefficient is calculated by the image projection processing circuit according to the following equation:
$$k = \frac{v \times ( {t}_{2} - {t}_{1} )}{( {x}_{2}^{′} - {x}_{1}^{′} )}$$
where k represents the scalar coefficient; v represents the speed of the vehicle; t1 represents the first time point; t2 represents the second time point; x′₁ represents the coordinate value of the first projected position along the first coordinate axis; and x′₂ represents the coordinate value of the second projected position along the first coordinate axis.

6. The adaptive and efficient depth estimation device of claim 4, wherein the image projection processing circuit is configured to calculate the first relative position of the target object at the first time point and the second relative position of the target object at the second time point in the world coordinate according to the scalar coefficient, coordinate values of the first projected position and the second projected position in the first coordinate axis and a second coordinate axis and a camera height of the image capturing module.

7. The adaptive and efficient depth estimation device of claim 6, wherein the first relative position of the target object at the first time point and the second relative position of the target object at the second time point in the world coordinate are calculated by the image projection processing circuit according to the following equation:
$${r}_{1} = [ \begin{matrix}{kx}_{1}^{′} \\ {ky}_{1}^{′} \\ k + h\end{matrix} ] , {r}_{2} = [ \begin{matrix}{kx}_{2}^{′} \\ {ky}_{2}^{′} \\ k + h\end{matrix} ]$$
where r₁ and r₂ represent the first relative position of the target object at the first time point and the second relative position of the target object at the second time point in the world coordinate, respectively; k represents the scalar coefficient; x′₁ represents the coordinate value of the first projected position along the first coordinate axis; x′₂ represents the coordinate value of the second projected position along the first coordinate axis; y′₁ represents the coordinate value of the first projected position along the second coordinate axis; y′₂ represents the coordinate value of the second projected position along the second coordinate axis; and h represents the camera height of the image capturing module.

8. The adaptive and efficient depth estimation device of claim 1, wherein the transform matrix is a homography transform matrix.

9. The adaptive and efficient depth estimation device of claim 1, further comprising:
an image correction circuit, configured to optimize the transform matrix according to at least one of a fish-eye undistortion parameter and a camera un-tilt parameter.

10. The adaptive and efficient depth estimation device of claim 9, wherein the image correction circuit is configured to generate the fish-eye undistortion parameter and the camera un-tilt parameter and optimize the transform matrix according to the fish-eye undistortion parameter and the camera un-tilt parameter during an off line execution phase, and the speed detection circuit, the image capturing module, the object detection circuit and the image projection processing circuit are utilized to determine the first relative position of the target object at the first time point and the second relative position of the target object at the second time point in the world coordinate during an on line execution phase.

11. An adaptive and efficient depth estimation method, applied for a vehicle, comprising:
(a) detecting a speed of the vehicle;
(b) capturing a first image at a first time point and a second image at a second time point;
(c) determining a first position of a target object in the first image and a second position of the target object in the second image; and
(d) converting the first position and the second position to a first projected position and a second projected position by using a transform matrix; and
(e) determining a first relative position of the target object at the first time point and a second relative position of the target object at the second time point in a world coordinate according to the speed of the vehicle, the first projected position and the second projected position.

12. The adaptive and efficient depth estimation method of claim 11, wherein the step of determining the first relative position of the target object at the first time point and the second relative position of the target object at the second time point in the world coordinate according to the speed of the vehicle, the first projected position and the second projected position comprises:
(a) calculating a scalar coefficient according to the speed of the vehicle, a time difference between the first time point and the second time point and a difference value between a coordinate value of the first projected position along a first coordinate axis and a coordinate value of the second projected position along the first coordinate axis; and
(b) calculating the first relative position of the target object at the first time point and the second relative position of the target object at the second time point in the world coordinate according to the first projected position, the second projected position and the scalar coefficient.

13. The adaptive and efficient depth estimation method of claim 12, wherein the step of calculating the scalar coefficient according to the speed of the vehicle, the time difference between the first time point and the second time point and the difference value between the coordinate value of the first projected position along the first coordinate axis and a coordinate value of the second projected position along the first coordinate axis determines the scalar coefficient according to the following equation:
$$k = \frac{v \times ( {t}_{2} - {t}_{1} )}{( {x}_{2}^{′} - {x}_{1}^{′} )}$$
where k represents the scalar coefficient; v represents the speed of the vehicle; t1 represents the first time point; t2 represents the second time point; x′₁ represents the coordinate value of the first projected position along the first coordinate axis; and x′₂ represents the coordinate value of the second projected position along the first coordinate axis.

14. The adaptive and efficient depth estimation method of claim 12, wherein the step of calculating the first relative position of the target object at the first time point and the second relative position of the target object at the second time point in the world coordinate according to the first projected position, the second projected position and the scalar coefficient comprises:
calculating the first relative position of the target object at the first time point and the second relative position of the target object at the second time point in the world coordinate according to the scalar coefficient, coordinate values of the first projected position and the second projected position in the first coordinate axis and a second coordinate axis and a camera height of the image capturing module.

15. The adaptive and efficient depth estimation method of claim 14, wherein the step of calculating the first relative position of the target object at the first time point and the second relative position of the target object at the second time point in the world coordinate according to the scalar coefficient, coordinate values of the first projected position and the second projected position in the first coordinate axis and the second coordinate axis and the camera height of the image capturing module determines the scalar coefficient according to the following equation:
$${r}_{1} = [ \begin{matrix}{kx}_{1}^{′} \\ {ky}_{1}^{′} \\ k + h\end{matrix} ] , {r}_{2} = [ \begin{matrix}{kx}_{2}^{′} \\ {ky}_{2}^{′} \\ k + h\end{matrix} ]$$
where r₁ and r₂ represent the first relative position of the target object at the first time point and the second relative position of the target object at the second time point in the world coordinate, respectively; k represents the scalar coefficient; x′₁ represents the coordinate value of the first projected position along the first coordinate axis; x′₂ represents the coordinate value of the second projected position along the first coordinate axis; y′₁ represents the coordinate value of the first projected position along the second coordinate axis; y′₂ represents the coordinate value of the second projected position along the second coordinate axis; and h represents the camera height of the image capturing module.

16. The adaptive and efficient depth estimation method of claim 11, wherein the transform matrix is a homography transform matrix.

17. The adaptive and efficient depth estimation method of claim 11, further comprising:
optimizing the transform matrix according to at least one of a fish-eye undistortion parameter and a camera un-tilt parameter.
